(19) United States
(12) Patent Application Publication
(10) Pub. No.: US 2025/0269468 A1
(43) Pub. Date: Aug. 28, 2025

(54) STEEL PLATE ASSEMBLY WELDED BY LASER WELDING AND LASER WELDING METHOD THEREOF

(71) Applicant: TAIWAN MASK CORPORATION, HSINCHU COUNTY (TW)

(72) Inventors: LI-WEN LAI, HSINCHU COUNTY (TW); WEI-LUN TSAI, HSINCHU COUNTY (TW); CHING-CHENG CHEN, HSINCHU COUNTY (TW); CHIH-HUI TAI, HSINCHU COUNTY (TW); HSIN-I HO, HSINCHU COUNTY (TW)

(21) Appl. No.: 18/586,824

(22) Filed: Feb. 26, 2024

(51) Int. Cl. B23K 26/26; F16B 5/08

(52) U.S. Cl. CPC B23K 26/26; F16B 5/08

(57) ABSTRACT

A steel plate assembly welded by laser welding and a laser welding method thereof are disclosed. The steel plate assembly comprises two steel plates and a molten region. The steel plates are joined. A joint face of the steel plates extends along a joint line. The molten region extends along the joint line. The molten region has a molten depth of between 20 and 50 mm. The molten region has a molten width of between 4 and 7 mm. The molten region is formed by welding the joint face using a laser. After the molten region is cooled and solidified, the steel plates are combined with each other. The molten depth is 20 to 50 millimeters, so the laser welding method is applicable to thicker steel plates.

### FIELD OF THE INVENTION

The present invention relates to a steel plate assembly welded by laser welding and a laser welding method for steel plates.

### BACKGROUND OF THE INVENTION

Using a laser to weld thick steel plates is a common technology nowadays. For example, Chinese Patent Publication No. CN 115106655 A discloses a laser welding method for medium and thick steel plates. By moving the laser beam back and forth at a high speed in the direction parallel to the thickness of the steel plates during laser welding, the heat of the laser beam in the direction of the thickness of the steel plates is guaranteed to be uniform. This reduces hole fluctuations caused by unstable air pressure due to uneven vapor plumes in the depth direction inside the laser hole during deep welding, thereby improving hole stability, reducing defects, such as pores, humps, and nail head weld bead, improving weld quality, enhancing the absorption of the laser beam by the metal in the small hole, increasing the molten depth.

However, in the aforementioned patent, the thickness of the steel plates is allowed to be about 10 millimeters. The laser welding method is not applicable to thicker steel plates.

### SUMMARY OF THE INVENTION

According to one aspect of the present invention, a laser welding method for steel plates is provided. The method comprises the following steps of: joining two steel plates, wherein a joint face of the steel plates extends along a joint line; using a laser to weld the joint face, wherein the laser has a power of between 20,000 and 30,000 watts, a welding angle is defined between the laser and the joint line, and the welding angle is between 0 degrees and 10 degrees; forming a molten region on the joint face using the laser, wherein the molten region extends along the joint line, the molten region has a molten depth of between 20 and 50 mm, and the molten region has a molten width of between 4 and 7 mm, after the molten region is cooled and solidified, the steel plates are combined with each other.

According to another aspect of the present invention, a steel plate assembly welded by laser welding is provided. The steel plate assembly comprises two steel plates and a molten region. The steel plates are joined. A joint face of the steel plates extends along a joint line. The molten region extends along the joint line. The molten region has a molten depth of between 20 and 50 mm. The molten region has a molten width of between 4 and 7 mm. The molten region is formed by welding the joint face using a laser. The laser has a power of between 20,000 and 30,000 watts. A welding angle is defined between the laser and the joint line. The welding angle is between 0 degrees and 10 degrees. After the molten region is cooled and solidified, the steel plates are combined with each other.

Preferably, at least one of the following conditions is met: a defocusing distance of the laser is between 0 and ±T/2 mm, T is a thickness of the steel plates; the laser has a power variation of ±3%, a wavelength of the laser is between 1030 and 1080 nanometers; a spot shape of the laser is circular or donut-shaped; a spot diameter of the laser is between 0.3 and 5 mm.

Preferably, when the steel plates are joined, the steel plates have a clearance range of not more than 5% of a width of the steel plates.

Preferably, the laser has a welding speed ranging from 5 to 80 millimeters per second.

Preferably, a protective gas is provided to remove a plasma generated during welding of the laser. The protective gas is one of argon, helium, nitrogen and carbon dioxide, or a combination thereof.

According to the above technical features, the present invention can achieve the following effects:

The molten depth is 20 to 50 millimeters, so the laser welding method is applicable to thicker steel plates.

The molten width W is between 4 and 7 mm, which can enhance the laser welding strength between the steel plates.

### BRIEF DESCRIPTION OF THE DRAWINGS

FIG. 1 is an exploded view of an embodiment the present invention;

FIG. 2 is a flow block diagram of the embodiment of the present invention;

FIG. 3 is a first schematic view of the embodiment of the present invention, showing the welding angle;

FIG. 4 is a second schematic view of the embodiment of the present invention, showing the defocusing distance;

FIG. 5 is a first photograph of the embodiment of the present invention;

FIG. 6 is a second photograph of the embodiment of the present invention;

FIG. 7 is a third photograph of the embodiment of the present invention; and

FIG. 8 is a fourth photograph of the embodiment of the present invention.

### DETAILED DESCRIPTION OF THE PREFERRED EMBODIMENTS

Embodiments of the present invention will now be described, by way of example only, with reference to the accompanying drawings.

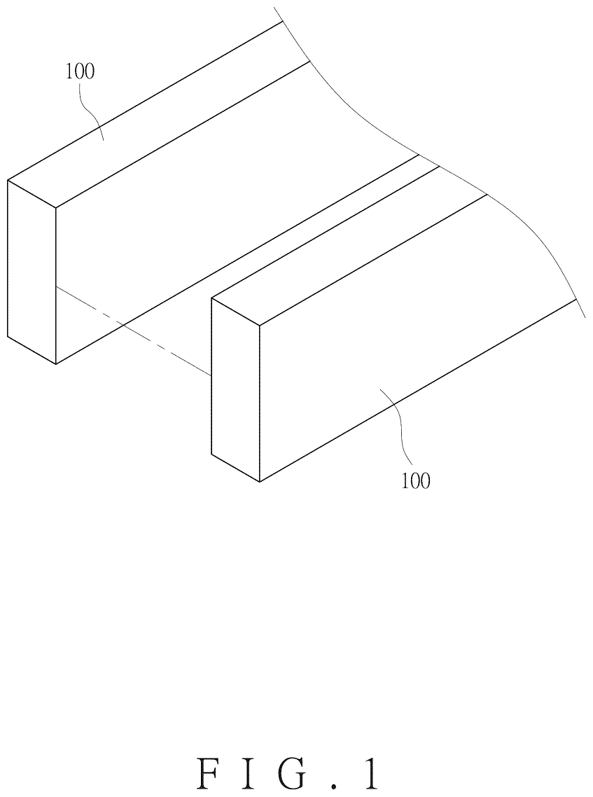

As shown in FIG. 1 through FIG. 3, the present invention discloses a steel plate assembly welded by laser welding and a laser welding method for steel plates.

The laser welding method for steel plates comprises the following steps:

Two steel plates 100 are joined. A joint face 1 of the steel plates 100 extends along a joint line L. The steel plates 100 have a clearance range of not more than 5% of the width of the steel plates 100.

The joint face 1 is welded using a laser 200. The power of the laser 200 is between 20,000 and 30,000 watts. A welding angle θ is defined between the laser 200 and the joint line L. The welding angle θ is between 0 degrees and 10 degrees.

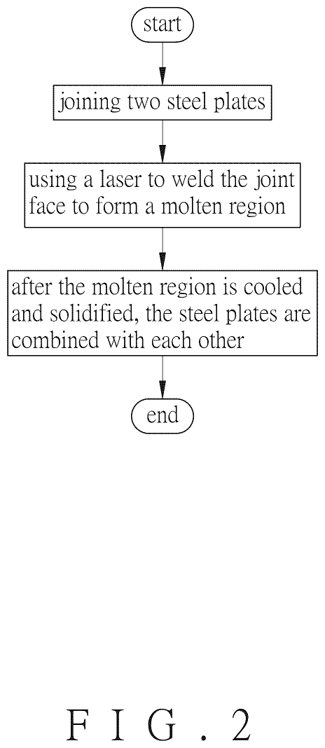

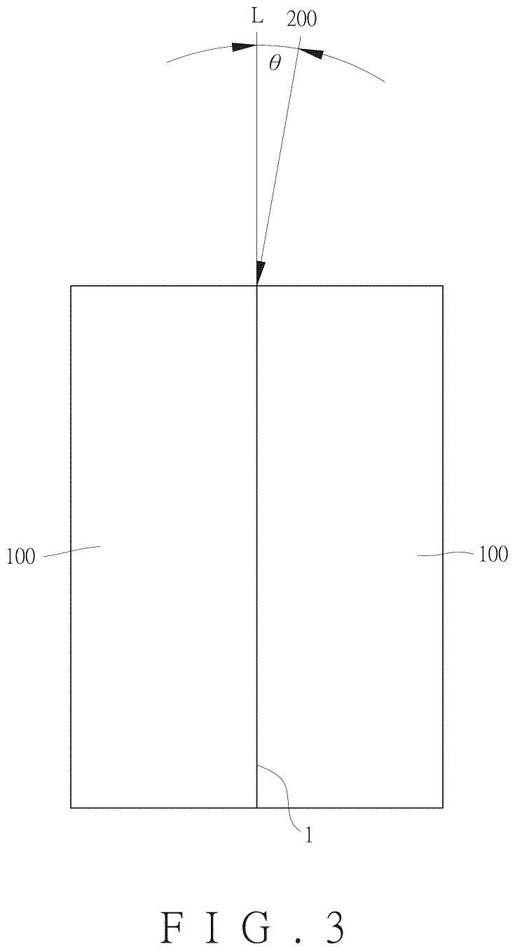

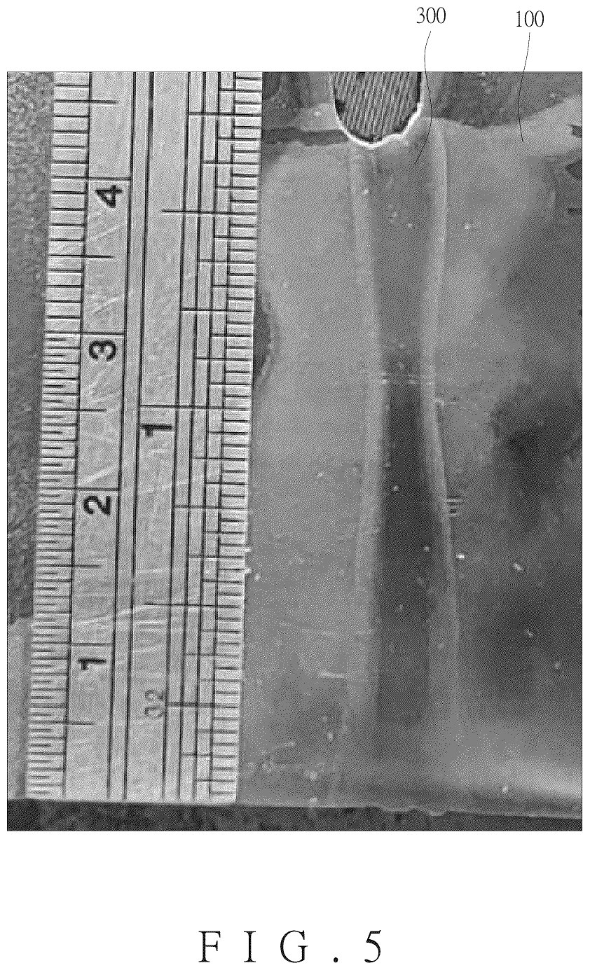

Please refer to FIG. 3 through FIG. 5, in cooperation with FIG. 2. When the joint face 1 is welded by the laser 200, a defocusing distance of the laser 200 is between 0 and ±25 mm. That is, the positive defocusing distance D1 is up to 25 mm, and the negative defocusing distance D2 is up to −25 mm, which is equivalent to half of the thickness T (between 20 and 50 mm) of the steel plates 100. If the surface of the steel plates 100 serves as the focal point 2, the positive defocusing point 3 will be 25 mm above the focal point 2, and the negative defocusing point 4 will be 25 mm below the focal point 2.

The laser 200 has a power variation of ±3%. The wavelength of the laser 200 is between 1030 and 1080 nanometers. The laser 200 has a welding speed ranging from 5 to 80 millimeters per second. Preferably, the spot shape of the laser 200 is circular or donut-shaped, and the spot diameter of the laser 200 is between 0.3 and 5 mm.

The above-mentioned values may be changed according to the thickness T of the steel plates. For example, when the thickness T of the steel plates is between 40 and 50 mm, the power of the laser 200 may be 30,000 watts, the welding speed is between 5 and 80 millimeters per second, and the spot diameter of the laser 200 is between 0.3 and 5 millimeters.

A protective gas is used to remove a plasma generated during the welding of the laser 200. The protective gas is one of argon, helium, nitrogen and carbon dioxide, or a combination thereof.

By changing the defocusing distance and the power variation, the laser 200 enables the joint face 1 to form a molten region 300 extending along the joint line L.

The molten depth of the molten region 300 is between 20 and 50 mm, which is equivalent to the thickness T of the steel plates 100. The molten width W of the molten region 300 is between 4 and 7 mm. After the molten region 300 is cooled and solidified, the steel plates 100 are combined with each other to form a steel plate assembly.

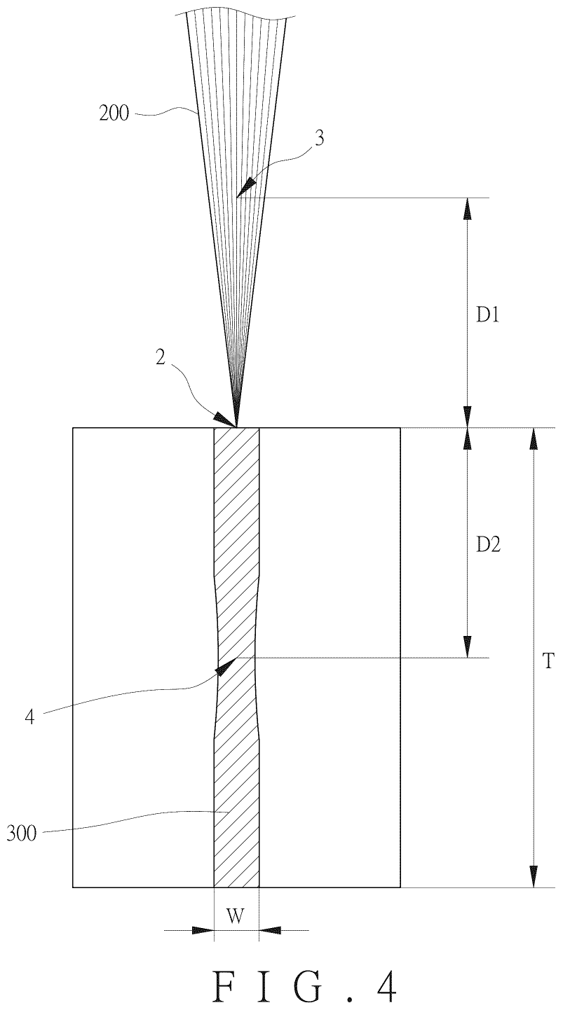

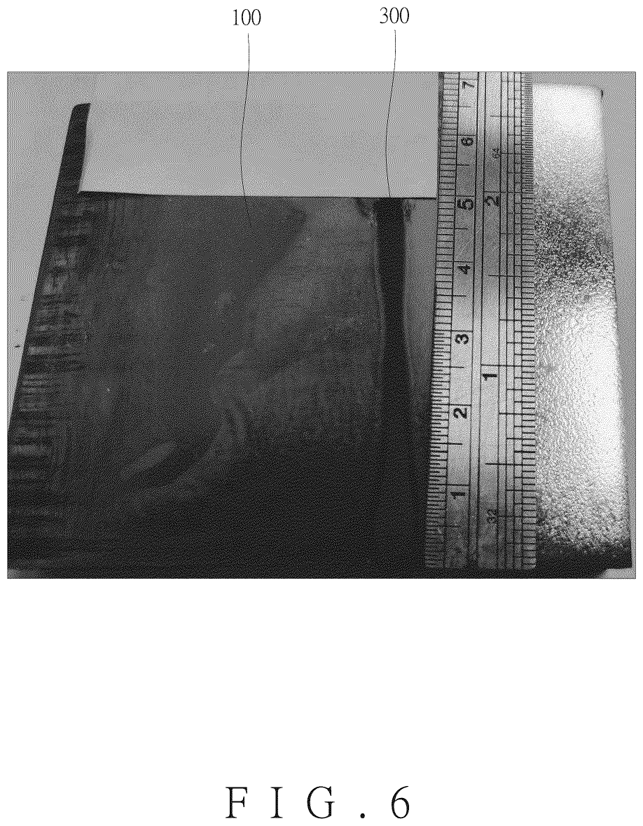

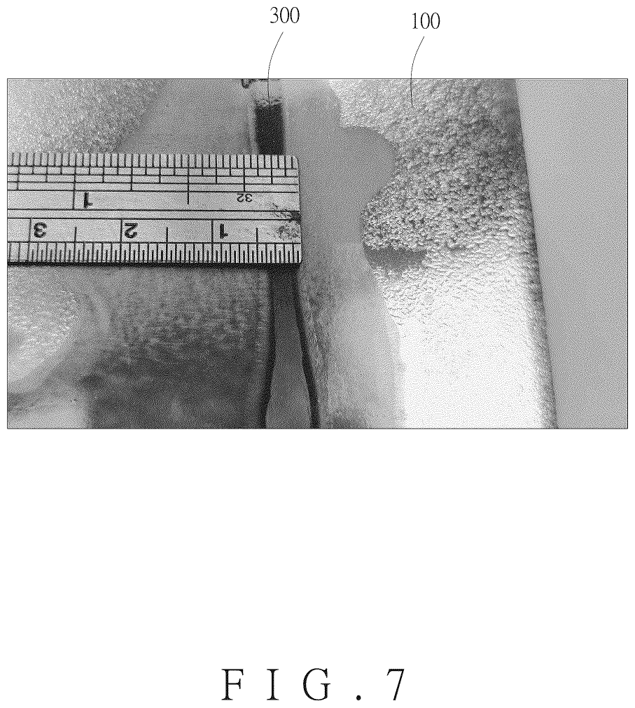

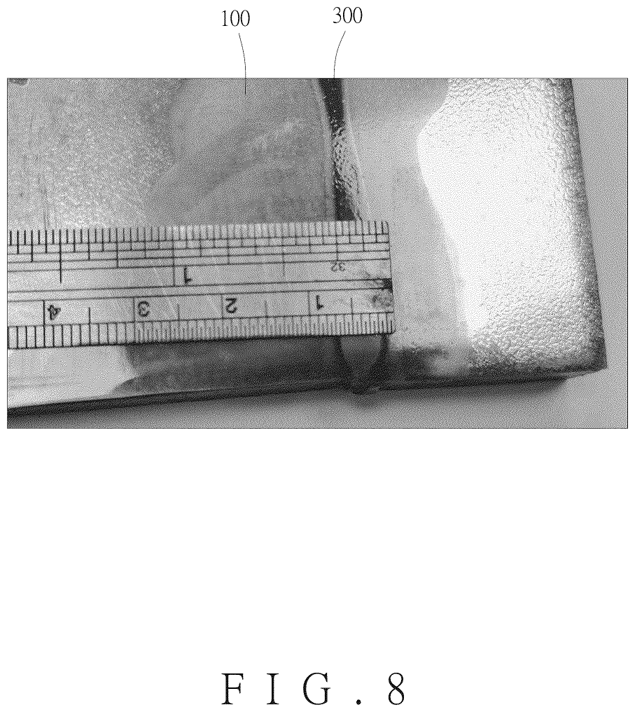

Please refer to FIG. 6 through FIG. 8, in cooperation with FIG. 4. As can be seen from the photographs of the actual steel plate assembly manufactured by the laser welding method, the molten depth is indeed up to 50 mm, and the molten width W is indeed between 4 and 7 mm.

The molten depth is 20 to 50 millimeters, so the laser welding method is applicable to thicker steel plates 100. The molten width W is between 4 and 7 mm, which can enhance the laser welding strength between the steel plates 100.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A laser welding method for steel plates, comprising the following steps of:
joining two steel plates, wherein a joint face of the steel plates extends along a joint line;
using a laser to weld the joint face, wherein the laser has a power of between 20,000 and 30,000 watts, a welding angle is defined between the laser and the joint line, and the welding angle is between 0 degrees and 10 degrees;
forming a molten region on the joint face using the laser, wherein the molten region extends along the joint line, the molten region has a molten depth of between 20 and 50 mm, and the molten region has a molten width of between 4 and 7 mm, after the molten region is cooled and solidified, the steel plates are combined with each other.

2. The laser welding method as claimed in claim 1, wherein at least one of the following conditions is met: a defocusing distance of the laser is between 0 and ±T/2 mm, T is a thickness of the steel plates; the laser has a power variation of ±3%, a wavelength of the laser is between 1030 and 1080 nanometers; a spot shape of the laser is circular or donut-shaped; a spot diameter of the laser is between 0.3 and 5 mm.

3. The laser welding method as claimed in claim 1, wherein when the steel plates are joined, the steel plates have a clearance range of not more than 5% of a width of the steel plates.

4. The laser welding method as claimed in claim 1, wherein the laser has a welding speed ranging from 5 to 80 millimeters per second.

5. The laser welding method as claimed in claim 1, further providing a protective gas to remove a plasma generated during welding of the laser, wherein the protective gas is one of argon, helium, nitrogen and carbon dioxide, or a combination thereof.

6. A steel plate assembly welded by laser welding, comprising:
two steel plates, the steel plates being joined, a joint face of the steel plates extending along a joint line;
a molten region, extending along the joint line, the molten region having a molten depth of between 20 and 50 mm, the molten region having a molten width of between 4 and 7 mm;
wherein the molten region is formed by welding the joint face using a laser, the laser has a power of between 20,000 and 30,000 watts, a welding angle is defined between the laser and the joint line, the welding angle is between 0 degrees and 10 degrees, after the molten region is cooled and solidified, the steel plates are combined with each other.

7. The steel plate assembly as claimed in claim 6, wherein at least one of the following conditions is met: a defocusing distance of the laser is between 0 and ±T/2 mm, T is a thickness of the steel plates; the laser has a power variation of ±3%, a wavelength of the laser is between 1030 and 1080 nanometers; a spot shape of the laser is circular or donut-shaped; a spot diameter of the laser is between 0.3 and 5 mm.

8. The steel plate assembly as claimed in claim 6, wherein when the steel plates are joined, the steel plates have a clearance range of not more than 5% of a width of the steel plates.

9. The steel plate assembly as claimed in claim 6, wherein the laser has a welding speed ranging from 5 to 80 millimeters per second.

10. The steel plate assembly as claimed in claim 6, wherein a protective gas is provided to remove a plasma generated during welding of the laser, and the protective gas is one of argon, helium, nitrogen and carbon dioxide, or a combination thereof.
